(19) United States
(12) Patent Application Publication
(10) Pub. No.: US 2012/0232942 A1
(43) Pub. Date: Sep. 13, 2012

(54) CONTROL AND TRACKING SYSTEM FOR MATERIAL MOVEMENT SYSTEM AND METHOD OF USE

(75) Inventors: Mark Gaug, Vestal, NY (US); Michael A. Heaton, Owego, NY (US); Eric Reisenaure, Owego, NY (US)

(73) Assignee: LOCKHEED MARTIN CORPORATION, Bethesda, MD (US)

(21) Appl. No.: 11/872,497

(22) Filed: Oct. 15, 2007

Related U.S. Application Data
(60) Provisional application No. 60/829,624, filed on Oct. 16, 2006.

(51) Int. Cl. G06Q 10/06; G06Q 50/28

(52) U.S. Cl. 705/7.12

(57) ABSTRACT

A system and method is provided for monitoring, tracking and/or coordinating the movement of items and/or equipment aboard a vessel. More particularly, a system and method is provided for controlling material flow, planning, reporting, scheduling, and inventory tracking of items throughout a vessel. The system comprises a computer infrastructure configured to receive item identification from remote sources and provide transporting instructions based on the item identification and predetermined criteria to operators for movement of cargo within a vessel. The system also includes at least one external device configured to at least receive the transporting instructions from the computer infrastructure.

### CROSS REFERENCE TO RELATED APPLICATIONS

The present application claims priority under 35 U.S.C. §119 to U.S. Provisional Application Ser. No. 60/829,624, filed on Oct. 16, 2006, the contents of which are incorporated herein by reference in their entirety.

### FIELD OF THE INVENTION

The present invention relates to a system and method of monitoring, tracking and/or coordinating the movement of items and/or equipment aboard a vessel and, more particularly, to a system and method of controlling material flow, planning, reporting, scheduling, and inventory tracking of items throughout a vessel.

### BACKGROUND DESCRIPTION

Current shipboard material movement subsystems (forklifts, package elevators, elevators, magazines) are manual and operate in an uncoordinated manner to store and retrieve ordnance and other cargo. Although there are systems for inventory and template tools to layout storage areas aboard a vessel, there is no coordination of the movement between personnel and subsystems.

By way of example, the loading and unloading of cargo to and from an aircraft carrier is a complex process involving hundreds of personnel. In an aircraft carrier, such processes take the coordination of countless personnel through many decks and areas on each deck. This requires much planning and coordination, which is not currently provided in real time visibility to the personnel.

Accordingly, there is a need for more efficient managing and processing of cargo, such as, for example, in vessels warehouses, etc.

### SUMMARY OF THE INVENTION

In a first aspect of the invention, a system environment comprises a computer infrastructure configured to receive item identification from remote sources and provide transporting instructions based on the item identification and predetermined criteria to operators for movement of items within a vessel. The system environment also includes at least one external device configured to at least receive the transporting instructions from the computer infrastructure.

In embodiments, the computer infrastructure is a centralized control management system (although a decentralized control management system is also contemplated by the invention). At least a bar code scanner and an RFID device receives the item identification and transmits the item identification to the computer infrastructure. The computer infrastructure is configured to provide real time status and control material flow, which includes at least one of planning, reporting, and scheduling of the items.

The predetermined criteria is at least one of: where the cargo or the item is expected to be used; type of the items; expected weather and sea conditions and/or current sea and weather conditions; trim of the vessel; arrival time; number of items in certain system queues; scheduling of equipment; assembly and disassembly locations; location of spare parts; characteristics of the items; current and expected storage space in certain locations; current Emission Control State; height of item cargo stacking; physical limits on a path to a storage location and at the storage location; actual and anticipated traffic flow on a path to the storage location to prevent collision; and personnel scheduling.

The computer infrastructure is configured to control and instruct automated, semi-automated or manual equipment. The item information is obtained by at least one of: a barcode scanner; an active or passive RFID device scanner; a profile scanner; a photo eye; a physical contact sensor or switch; and a vision system. The detecting item location and/or characteristics includes at least one of: a thermometer or other temperature measuring device; a gas sensing instrument; a radioactivity sensing instrument; a biohazard sensing instrument; an audio signal device; a device that senses wires, light reflective paint, or emitters embedded in a floor or deck or near material movement passageways; an optical scanner; a device that senses emitters embedded in vehicles or material movement devices; and a weight measurement device.

The computer infrastructure is configured to monitor the location of the items. The computer infrastructure is configured to monitor a path of travel of the items. The computer infrastructure is configured to use historical information of the items to determine a path of travel. The computer infrastructure is configured to be overridden by the at least one external device. The computer infrastructure is configured to interface with at least one of inventory and supply systems, local or off-ship supply systems, shipboard databases and external databases, monitoring equipment throughout the vessel, and same or disparate systems from same or different manufacturers. The computer infrastructure is configured to provide inventory information of the items and reconcile the items with a manifest. The computer infrastructure is configured to calculate space and/or scheduling requirements for in system equipment and item queuing; and deliver the items using a preset schedule at certain defined times. The external device is configured to at least one of provide status and identification information to the operator about the items and override systems under control of the computer infrastructure or instructions received by the computer infrastructure, which are provided to other external devices.

In another aspect of the invention, a system comprises a computer infrastructure which is configured to receive item information from at least one remote sensing device at locations throughout a vessel. The computer infrastructure uses the item information to determine and provide different real-time scheduling information and transportation paths of items associated with the item information to various users, and continually update information about a location and the transportation paths of the items as the items travel to various locations of the vessel.

In embodiments, external devices are configured to receive the scheduling information and real-time updated information about the transportation paths of the items at various locations as the items are detected or moved to the various locations. The detecting mechanisms detect the locations of items and/or equipment and may be provided at various locations. The detecting mechanisms are one of stationary and mobile. The external device is configured to override the instructions of the computer infrastructure. The external device is configured to provide at least one of searching and inspection capabilities to the users.

In another aspect of the invention, a method comprises: receiving item information of a plurality of items as they are received; receiving location information of the plurality of items as they travel throughout space; coordinating in real-time product paths and scheduling of the plurality of items based on a location of the plurality of items and the item information; and providing different scheduling information and product paths to different users at different locations based on the coordinating in real-time the product paths and the scheduling of the plurality of items. The method further comprises reconciling the item information with a final storage destination for each of the plurality of item.

In yet another aspect of the invention, a method of coordinating material flow through a vessel, comprises: inventorying items as they are received at different stations throughout the vessel; tracking the items as they are moved to different locations throughout the vessel; and providing different real-time scheduling and transportation information to users at different stations throughout the vessel based on item criteria, movement of the items throughout the vessel and current location of the items at particular stations.

### BRIEF DESCRIPTION OF THE DRAWINGS

The present invention is described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a top view of a vessel, implementing the system and method of the present invention;

FIG. 2 is a cross sectional side view of a vessel, implementing the system and method of the present invention;

FIG. 3 shows an illustrative environment for implementing aspects of the invention;

FIG. 4 is a schematic diagram implementing aspects of the invention;

FIG. 5 is a flowchart showing exemplary steps of flight deck strike-down operations in accordance with the invention;

FIG. 6 is a flowchart showing exemplary steps of hangar deck strike-down operations in accordance with the invention;

FIG. 7 is a flowchart showing exemplary steps of magazine deck strike-down operations in accordance with the invention;

FIG. 8 is a flowchart showing exemplary steps of magazine deck strike-up operations in accordance with the invention;

FIG. 9 is a flowchart showing exemplary steps of unpack area strike-up operations in accordance with the invention;

FIG. 10 is a flowchart showing exemplary steps of hangar deck strike-up operations in accordance with the invention;

FIG. 11 is a flowchart showing exemplary steps of flight deck strike-up operations in accordance with the invention;

FIGS. 12 and 13 are flowcharts showing exemplary steps of magazine movement operations in accordance with the invention; and

FIGS. 14, 15, 16a-16c and 17a-17b show exemplary displays of external devices implementing aspects of the invention.

### DETAILED DESCRIPTION OF EMBODIMENTS OF THE INVENTION

The present invention relates to a system and method of monitoring, tracking and/or coordinating the movement of cargo (items) and equipment aboard a vessel. More particularly, the invention is directed to a system and method of controlling material flow, planning, reporting, scheduling, and inventory tracking of items throughout a vessel. In one preferred embodiment, the system and method is directed to shipboard material handling for an aircraft carrier or other type of vessel. The present invention is also applicable to warehouse and factory implementations with multiple processes and/or multiple floors, and just in time manufacturing/delivery implementations.

In implementation, the system and method of the present invention automates and controls the process of planning, coordinating, and controlling the internal movement of cargo (items) aboard a vessel. This includes, for example, the automation of real time status, controlling material flow, planning, reporting, scheduling, and inventory for shipboard movement of the items. These items range from ordnance, to foodstuff, to other items needed to maintain operations on a vessel.

Many advantages are achieved by implementing the system and method of the invention. For example, the system and method of the invention provides real time visibility to all authorized personnel for the material movement process aboard the vessel. This is accomplished by the use of computing devices, e.g., handheld devices, which enable all authorized personnel the ability to determine the exact location of items, the intermediate and final destination of items, as well as the ability to coordinate movement of the items with other personnel throughout the vessel. This allows for more efficient movement of items, which results in less time away from critical and sensitive operational missions.

In one particular advantageous scenario, the system and method of the invention allows for the automated tracking and data gathering of all ordnance on the vessel. As further advantages of implementing the system and method of the invention, it is now possible to:
Reduce interfacing with other systems (for instance, reducing the clerical work of filling supply forms and interfacing to ship inventory systems);
Improve operational capabilities of ordnance material handling under multiple operational conditions, e.g., higher sea states, organizing ordnance for the next sortie mission, etc.;
Control systems on board the vessel such as, for example, vehicle traffic and movement as well as other systems;
Facilitate material planning and coordination before a move;
Incorporate real-time movement control systems;
Improve and coordinate the planning for a “Strike-up” or Strike-Down” operations; and
Automatically and systematically report and track cargo in real time by item Identification Number.

### Exemplary Environmental Uses Implementing Aspects of the Invention

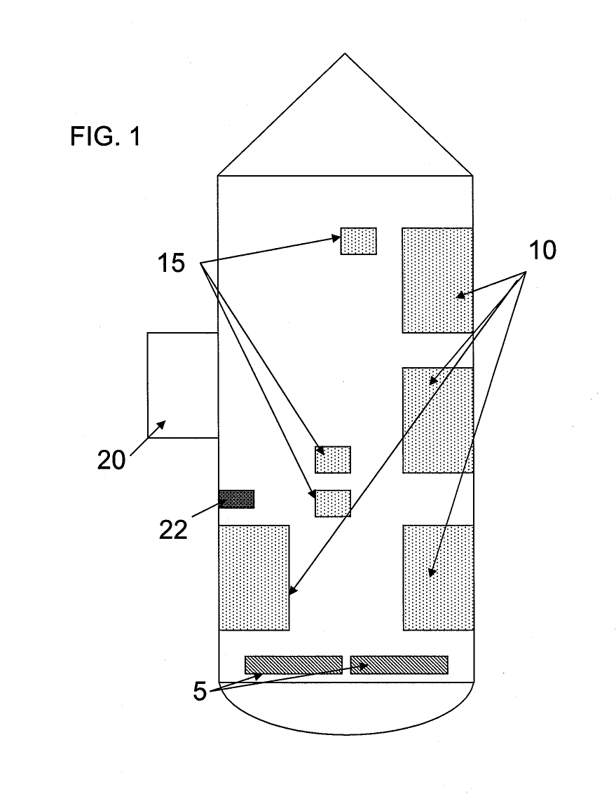

FIG. 1 is a top view of a vessel implementing the system and method of the present invention. Although the vessel of FIG. 1 is generally representative of an aircraft carrier, the system and method of the present invention (e.g., material movement control and planning system) is equally applicable to other sea bearing environments. The vessel of FIG. 1 includes access stations 5, elevators 10 and 15 and at least one side access door 20. In embodiments, the vessel also includes an “ordnance farm” access station 22. As used herein, the term ordnance refers to bombs, missiles, warheads, bullets, munitions, etc., or any combination thereof.

In the implementation of an aircraft carrier, for example, the access stations 5 are located at the aft portion of the vessel and are used as primary stations to receive ordnance via vertical replenishment maneuvers (VERTREP). By way of example, in VERTREP maneuvers, more than one helicopter drops cargo of ordnance on the flight deck at the access stations 5. It should be understood by those of skill in the art, though, that the access stations 5 may be in other locations and used for other replenishment purposes, depending on the particular class of vessel and, as such, the present invention should not be limited to the number or position of access stations described herein.

The elevators 10 may be aircraft elevators and the elevators 15 may be ordnance elevators; although other types of elevators are also contemplated by the invention such as, for example, general purpose elevators used for foodstuff or other items necessary for shipboard operations. An elevator is a mechanical device to vertically raise or lower material to a location. In one implementation, the ordnance elevators 15 extend to a magazine level or levels. As should be understood by those of skill in the art, a magazine is an ordnance storage area. In a Nimitz class aircraft carrier, for example, there are approximately 44 ordnance storage magazines, each normally served by a primary elevator and a secondary elevator. Ordnance is normally split up between forward and aft magazines to assure near normal operation, even when there may be battle damage aboard the vessel.

The side access door (or doors) 20 is used to load and unload items directly to the hangar deck or other decks below the upper or main deck. The side access door 20 may be used for underway-connected replenishment maneuvers (CONREP). CONREP are maneuvers where cables connected between vessels are used to carry cargo from one vessel to another vessel. In CONREP maneuvers, the cargo is received at access stations called “conrep stations”. In one implementation using an aircraft carrier, for example, there are three conrep stations on the hangar deck on the starboard side (e.g., close to the aircraft elevators) of the vessel. CONREP is typically used to carry dry goods and to transport fuel by hoses.

The “bomb farm” access station 22 (generally referred hereto as an “ordnance farm”) is the end point for all ordnance prior to being loaded on an aircraft on the flight deck. Ordnance that return to the flight deck from aircraft also sometimes get returned to the “ordnance farm” access station 22 for strike-down operations to the magazines.

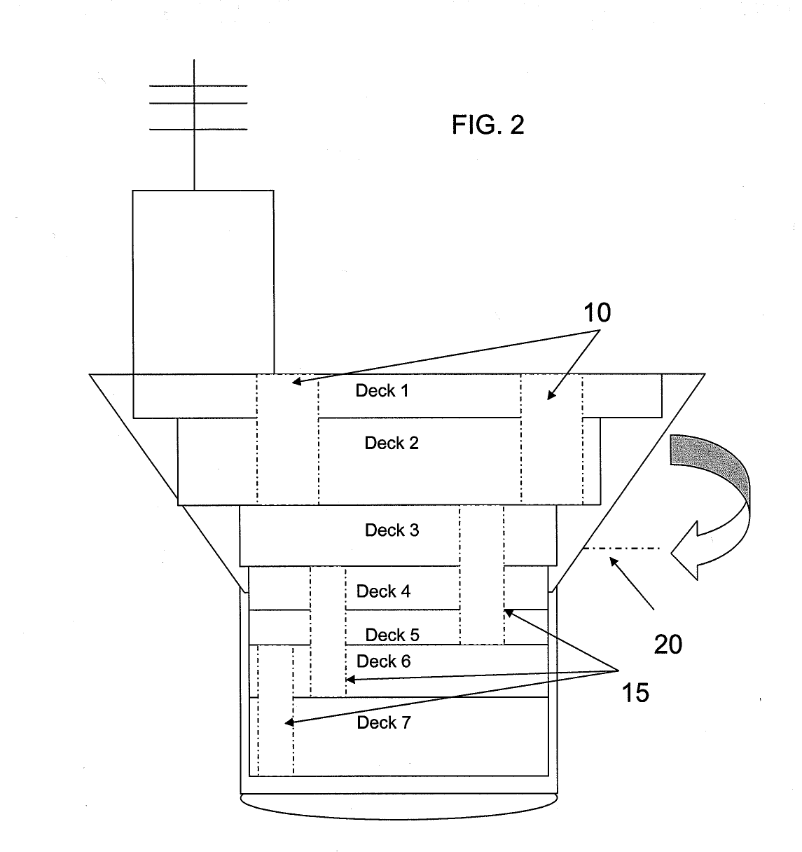

FIG. 2 is a cross sectional side view of a vessel. In embodiments, the vessel of FIG. 2 is also representative of an aircraft carrier, but can equally be any vessel. In the illustrative example of FIG. 2, the vessel includes seven decks, in which the system and method will operate and coordinate movement of cargo (items). These decks are numbered decks 1-7. In one illustrative, non-limiting example, the decks include the flight deck, hangar deck and magazine decks. The flight deck is typically the uppermost deck; whereas, the hangar deck is immediately below the flight deck and the magazine decks are below the hangar deck.

For safety reasons, the layout of the elevators 10 and 15 are designed in such a manner that the elevators 10 and 15 will not extend directly from the flight deck to the magazine levels. In fact, in a deliberate design decision for safety reasons, the elevators 15 will only extend between the magazine levels and the hangar deck, and a separate set of elevators 10 are required to transport ordnance from the flight level to the hangar level. The elevators 15 may also extend between magazine levels such that, in some cases, some elevators 15 can be dedicated to transporting ordnance between magazine levels, alone.

### Exemplary Computing Infrastructure and Environment Implementing Aspects of the Invention

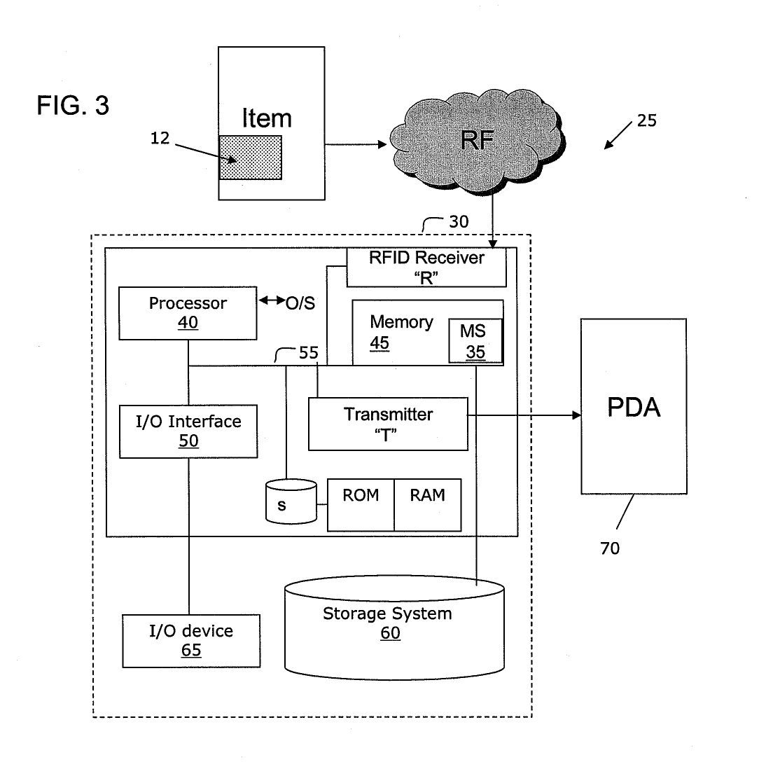

FIG. 3 shows an illustrative environment 25 for managing the processes in accordance with the invention. More particular, the illustrative environment 25 is configured and structured to monitor, track and/or coordinate the flow of items, e.g., ordnance, foodstuff, throughout a vessel, for example. In one preferred embodiment, the system and method is implemented as a shipboard material handling system for an aircraft carrier or other type of vessel.

The environment 25 includes a computer infrastructure 30 that can perform the processes described herein. The computer infrastructure 30 can be representative of any general purpose computing article of manufacture capable of executing computer program code installed thereon (e.g., a personal computer, server, handheld device, etc.). To this extent, in embodiments, the functionality provided by the computer infrastructure 30 can be implemented by any combination of general and/or specific purpose hardware and/or computer program code.

The computer infrastructure 30 is also configured to interface with existing supply systems, e.g., RSupply (Relational Supply Optimized), MILSTIP and tracking spreadsheets to name a few. More specifically, the computer infrastructure 30 is configured to interface with inventory and supply systems, local or off-ship supply systems, shipboard databases and external databases, monitoring equipment throughout the vessel, and/or any subsystems from multiple manufacturers or disparate systems from the same or different manufacturers. Also, the computer infrastructure 30 includes plug-in dynamically linked libraries to interface to different communication protocols, where the computer infrastructure preferably uses a service oriented architecture (XML Web services communicating with HTTP SOAP messages) between the system controllers and subsystems.

The computer infrastructure 30 includes a management system 35, which makes the computer infrastructure 30 operable to coordinate the movement, inventory, etc. of items throughout the vessel, e.g., process described herein. In more particularity, the management system 35 is configured and structured to manage and coordinate the movement of the items throughout the vessel, including, for example, from receipt of such items, to the storage of such items, to the consumption of such items, e.g., from cradle to grave. As one illustrative non-limiting example, the management system 35 is configured to receive (whether remotely of via a local download) a description of the items, e.g., manifest, to be received on the vessel. This description may be in the form of an identification number or other type of identification such as, for example, bar code information. Once the items are received on board, the management system 35 can confirm and reconcile receipt of such items (by comparing to a manifest) and can dynamically instruct automated equipment or shipboard personnel to the movement and storage of such items (by mapping the items to predetermined locations). As to inventorying functions, the computer infrastructure 30 can build a requisition list of items arriving and departing and can also verify receipt of the cargo against the manifest. As to movement and storage of items, the processes include the coordination and timing of movement of items throughout the vessel to its final storage (or use), while avoiding collision, and providing transport paths taking into account other activities about the vessel, as described in greater detail herein.

The computer infrastructure 30 includes an RFID receiver “R”. The RFID receiver “R” is configured to receive RFID signals generated from an RFID tag 12 on an item, as discussed in greater detail below. In additional or alternative embodiments, the computer infrastructure 30 can receive item identification from a handheld scanner (external device 70), via the use of bar code technology or manual input or other technologies discussed herein. The item identification (whether from the RFID or other mechanism) is transmitted to the computer infrastructure 30, via a communication link as discussed below. Once the item identification is received, it may be stored in the external storage 60, for example. This information, which may be reconciled to specific item characteristics such as, for example, weight, size, type of item, etc. can then be dynamically processed for future use in accordance with the aspects of the present invention. The inventoried items (received items) can be compared to stored item description information and final destination location information in order to instruct personnel as to the storage or use location of the items and a best path for transport.

In addition to the above noted features, the computer infrastructure 30 can be configured to determine an intermediate or final destination of an item based on different criteria. For example, such criteria includes, amongst other possibilities:
where cargo or item is expected to be used;
type of cargo or item (refrigerated, non-refrigerated, ordnance, etc.);
dimensions of the cargo (weight shape, etc.);
expected weather and sea conditions or current sea and weather conditions based on known monitoring systems;
trim of the vessel;
arrival time of the order;
number of items in certain system queues;
scheduling of elevators, vehicles, conveyors or other equipment in the system;
assembly and disassembly locations;
location of spare parts;
characteristics of the items (e.g., toxicity, flammability, biological, radioactivity);
current and expected storage space in certain locations;
current Emission Control State;
height of cargo stacking without exceeding weight and stacking limits;
physical limits (size and weight) on the path to the storage location and at the storage location;
actual and anticipated traffic flow on the path to the storage location to prevent collision and to provide fastest or most efficient traffic path;
maximum size of cargo that can fit down a path to the storage area; and/or
personnel scheduling.

In embodiments, criteria is set by configuration parameters and/or scripts. The criteria can also be manually input into the computer infrastructure. The criteria can be sent to the computer infrastructure with discrete inputs from other systems, whether on the vessel or at a central location. Thus, using the criteria, the computer infrastructure can, in addition or complementary to the other features described herein: calculate space and/or scheduling requirements for in system equipment and cargo queuing; and/or deliver cargo using a preset schedule at certain defined times. The computer infrastructure can also search the databases (internal or external) for historical information to predict scheduling times and items and coordinate movement of the equipment and cargo; although, based on current information, the coordination and movement of the equipment and cargo can be changed to accommodate current situations.

In addition, the computer infrastructure 30 includes a processor 40, a memory 45, an input/output (I/O) interface 50, and a bus 55. The bus 55 provides a communications link between each of the components in the computer infrastructure 30. The processor 40 interfaces with any known operating system (O/S). The memory 45 is configured to, in embodiments, store the management system 35. The management system 35 may also be stored in an internal database “s” or the external storage 60. The item description information, a map of the vessel including loading, unloading and destination locations can also be stored in the internal database “s” or the external storage 60. The internal database “s” or the external storage 60 can also store the above-identified criteria. The internal database “s” or the external storage 60 can also include an inventory of equipment on the vessel including forklifts, elevators, and their respective assignment location, etc., all of which is used by the computer infrastructure 30 to assign equipment to the cargo.

In operation, the item description information is compared with the inventoried (recently received) items and mapped to a final destination in order to instruct personnel as to the final storage location (or other location) of the received items and a best path for transport. As equipment and cargo is transported, the database “s” or external storage 60 is updated with the new information (e.g., location of equipment, equipment in use and in queues and queue location, item location, etc.) so that the computer infrastructure can continue to assign cargo and provide instructions to personnel in real-time. This update can be done by the RFID tags, bar code and/or manual input.

The computer infrastructure 30 is in communication with an external I/O device/resource 65. The external I/O device/resource 65 may be any device that enables an individual to interact with the computer infrastructure 30. For example, the external I/O device/resource 65 may be keyboards, displays, pointing devices, etc. The computer infrastructure 30 is also in communication with an external device 70, e.g., personal digital assistant (PDA), used by shipboard personnel to receive instructions from the computer infrastructure 30 in order to manage and coordinate the transportation of the items aboard the vessel, as discussed herein. The external device 70 may also be representative of any currently used computing system used on a vessel. The external device 70 may be used by shipboard personnel to provide location information, item status, etc. of items to the computer infrastructure 30, as further discussed below.

The communication link between the computer infrastructure 30 and the external I/O device/resource 65 and the external device 70, e.g., personal digital assistant, can be any type of communication link such as, for example, any combination of wired and/or wireless links; any combination of one or more types of networks (e.g., the Internet, a wide area network, a local area network, a virtual private network, etc.); and/or any combination of transmission techniques and protocols. The communication link to the external device 70 may be provided through a transmitter “T”.

The computer infrastructure 30 is modular and includes redundant components that allow the system to remain operational in case of component failure or a severe loading in a part of the system. The computer infrastructure 30 is also configured to perform configuration management on hardware and software and provide a report when the hardware and/or software do not match configuration data. The computer infrastructure 30 is further configured to automatically update operational software when current software versions do not match configuration data. The computer infrastructure 30 is configured to backup system data and to automatically initiate redundant systems to meet material movement obligations.

Additionally, when a subsystem or component fails or goes into a degraded mode of operation, the computer infrastructure 30 automatically reroutes material movement around the failed subsystem. The computer infrastructure 30 is also configured to predict failures, using known failure algorithms, based on data provided from subsystems, schedule non-supervised downloading of operational software to subsystems, and update operational software once it is downloaded. In further embodiments, the computer infrastructure 30 is configured to provide audit messages, automatically purge older files, report events from operational software (via email, pager or to the external devices), record maintenance actions, and allow remote restart and troubleshooting monitoring to subsystem elements.

In sum and as should be understood in view of the description herein, the computer infrastructure 30 is configured to provide the advantages and functionality as described above. These advantages and functions include, but are not limited to:
Automate real time status of items on board a vessel;
Control material flow throughout the vessel by maintaining track and monitoring the items on board and dynamically instructing shipboard personnel, in a coordinated manner, as to the movement and placement of such items throughout the vessel;
Inventory items aboard the vessel via use of the external devices and/or RFID;
Provide status, e.g., location, inspection information, final destination information, to shipboard personnel via the external device;
Reduce interfacing with other systems (for instance, reducing the clerical work of filling supply forms and interfacing to ship inventory systems); and
Improve operational capabilities of ordnance material handling under multiple operational conditions, e.g., higher sea states, organizing ordnance for the next sortie mission, etc.

### Exemplary Implementation of Aspects of the Invention

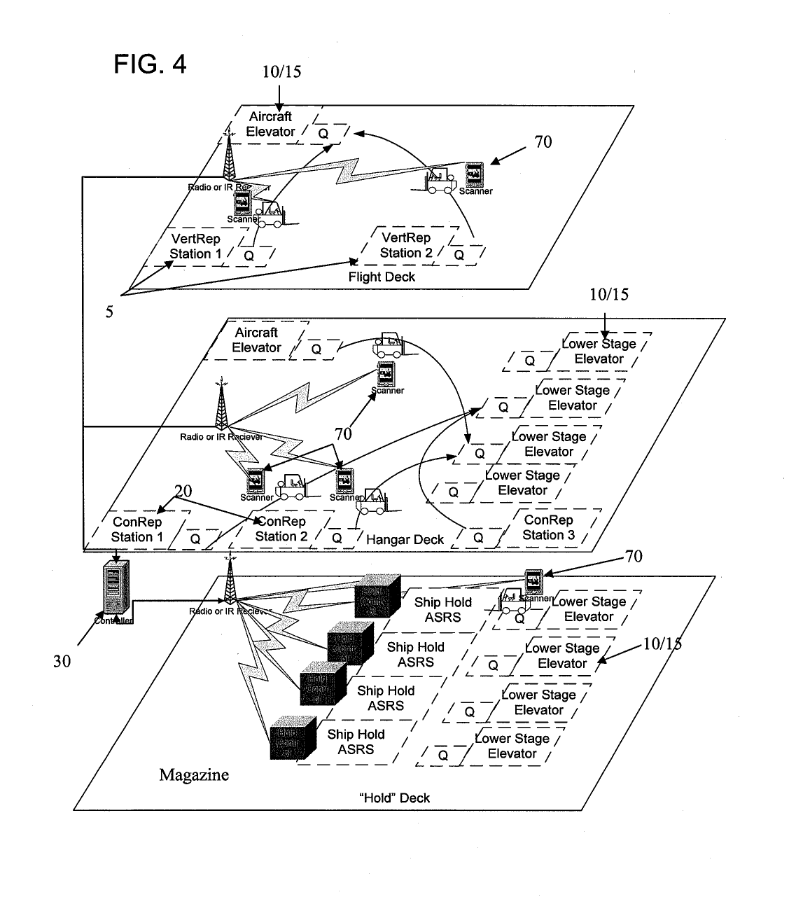

FIG. 4 is a schematic diagram implementing aspects of the system and method of the invention. As shown and described with reference to FIG. 4, and as should be appreciated by those of skill in the art, the coordination, management, monitoring, tracking and inventorying of items aboard a vessel is a very complex and daunting task, especially aboard military vessels. For example, prior to the invention, shipboard material movement subsystems (e.g., forklifts, package elevators, elevators, magazines) operated in an uncoordinated manner to store and retrieve ordnance and other items, involving potentially hundreds of personnel. Thus, the process of tracking and coordinating item storage, retrieval, etc, involves many different people, much planning and coordination, and personnel did not have real time visibility into material movement that is taking place.

However, as shown representatively in FIG. 4, the shipboard material movement processes are now coordinated by the computing infrastructure 30, communicating with the many different personnel and systems throughout the vessel. By way of example, forklift operators are equipped with automatic identification detecting scanners (RFID) and external devices (e.g., handheld device). The handheld devices can also be barcode scanners, RFID scanners and can include manual inputs such as a keyboard or touch screen. The manual inputs allow the operator to enter material identification and request location information, inspection information, and item information, amongst other functions. The automatic identification detecting scanners (and barcode scanners) permit the operator to automatically enter product identification information, upon receipt on the vessel as well as throughout the transporting process through many different stages. The handheld devices also provide instructions to the operators as to the arrival of items, the location of transport of such items, the path taken for the transport of such items, as well as a host of other information ranging from inspection information, to final destination information, etc.

Although FIG. 4 is described with reference to strike-down operations, one of skill in the art will realize that the same or similar processes described herein are equally applicable to strike-up operations. Fundamentally, the differences between strike-up and strike-down operations include, for example, in strike-up operations, cargo is not transported to conrep stations and access stations; whereas, in strike-down operations, the cargo is transported from conrep stations and access stations. Also, in strike-up operations, ordnance is delivered to ordnance farms and/or assembly areas, as one will appreciate in view of the discussion below. In any event, the coordination, material flow, inventory, scheduling, etc. and infrastructure used herein, without departing from the spirit and scope of the claimed invention, is equally applicable to both strike-up operations and strike-down operations. Moreover, the coordination, material flow, inventory, scheduling, etc. and infrastructure used herein is also applicable to any movement of items aboard any type of vessel, and although especially adapted to military applications also clearly has civilian use applications (e.g., large cruise ships, etc.)

Also, although FIG. 4 is described with reference to certain locations and types of equipment, other locations and equipment are also contemplated by the present invention. For example, although not an exhaustive list, the system and method of the invention is configured to control and manage the movement of cargo originating from any location on a vessel to any intermediate or final destination. These locations may be, for example:
In a same cargo hold as the destination location;
In a different cargo hold on the same deck as the destination location;
A cargo hold on a different deck as the destination location;
An elevator or queue awaiting an elevator;
A package conveyor;
A cargo inspection area;
Where cargo enters or departs from the vessel while docked, during connected replenishment and/or vertical replenishment;
Where cargo enters the ship by crane or through a wet well;
A queuing location used for temporary storage of cargo;
A cargo assembly area;
A cargo break down location;
An area where cargo is consumed;
A package conveyor; and/or
A cargo inspection area.

Also, the system and method of the invention can be configured to control and instruct any type of automated, semi-automated or manual equipment. For example, the equipment may include, but not limited to:
An elevator;
A package conveyor;
A robot or automatic guided vehicle;
A human assisted device;
A manual, semiautomatic, of fully automatic forklift;
A connected replenishment transfer apparatus;
A conveyor;
A tray movement system;
A manual transportation device couple to an operator with system display;
An overhead lift;
A top lift transportation device; and/or
A crane.

Although bar code scanners and RFID technologies are preferably used with the invention, the identity and position or relative position of the cargo and equipment may be provided by many different position sensing devices, known to those of skill in the art. By way of example, the sensors may include, amongst others:
A barcode scanner;
An active or passive RFID device scanner;
A profile scanner;
A photo eye;
A physical contact sensor or switch;
A vision system where the system determines positioning from differing levels of lighting on a light sensitive array;
A device which uses an audio signal to detect objects;
A device that uses a time signals travels to a object to determine relative position;
A device that senses wires, light reflective paint, or emitters embedded in a floor or deck or near material movement passageways;
A device that senses emitters embedded in vehicles or material movement devices;
A thermometer or other device to measure temperature of cargo or items;
Gas sensing instrument;
A radioactivity sensing instrument (Geiger counter);
A biohazard sensing instrument;
Weight measurement device such as scale; and/or
An optical scanner

### Upper Deck Operations

By way of more specific explanation of FIG. 4, three decks are shown for illustrative purposes: a flight deck, a hangar deck and a hold deck (e.g., magazine deck). Initially, ordnance and other cargo are dropped on the deck, via VERTREP operations, at the access stations 5. Typically, it takes about 14-20 personnel to begin the process of unloading the ordnance and other cargo from the access stations 5 to the queues and elevators 10/15. Once on the flight deck, operators will inventory the items by use of the automatic identification detecting scanners, bar code scanners or manual input (or other devices mentioned herein). This information is then transmitted to the computer infrastructure 30 and stored in the external storage, for example, for later use in accordance with the invention. The automatic identification detecting scanners can transmit the identification and location information to the computer infrastructure 30 via a radio or IR tower/receiver located throughout the vessel, preferably on each deck. The detecting mechanisms can be on the forklifts or at specified locations such as at the elevators or access, conrep or queuing stations.

Under the instruction of the computer infrastructure 30, each of the operators will be instructed to place certain ordnance and/or other items in particular locations, whether in queues or on certain elevators in a certain order. The operators are notified and instructed of such coordinated efforts individually or in teams via the external devices 70. As the computer infrastructure 30 is configured to dynamically plan and coordinate the movement of the cargo (and, in certain embodiments, the movement and control of equipment), each item can be placed and transported according to a real-time updated scheduling plan.

For example, an operator can be instructed to place specific items in a first and second queue and other items in one ore more elevators 10/15 based on the criteria noted above. As any of the elevators 10/15 become full (in embodiments, determined by the computer infrastructure or manually) and instructed to transport the cargo to a lower deck for unloading, the computer infrastructure 30 will instruct the operators to begin placing all items in the second queue. The computer infrastructure 30 may control elevator movement by allowing a constant and configurable time to close/open the door/hatch, a time (per floor) to allow for internal doors to open and close, and the standard configurable acceleration/deceleration for elevator motion

After the elevator is unloaded at the lower deck and brought back to the flight deck, the computer infrastructure 30 may instruct the operators to break up into teams, where one team places certain items from the second queue into the elevator while the other team will bring items directly from the access stations 5 to the elevator. In operation, the computer infrastructure 30 instructs the operators to move certain items to certain locations through a certain transport path to coordinate the movement of the teams. This can be accomplished as the computer infrastructure 30 has the specific items and their dimensional characteristics, the location of the items and the capacity of the elevators stored in its database (external or internal storage).

As in any of the embodiments and at any location throughout the vessel, cameras can be used to determine cargo and equipment orientation so that the computer infrastructure 30 can detect the exact location and orientation of such cargo and equipment. This will allow a vision system, for example, to determine how to grasp, pick up or handle cargo. Also a sensor such as, for example, a pressure device on the forklift, can also provide an indication to the computer infrastructure 30 that movement of a particular item is complete and that the system can proceed with automatic or other cargo movement.

### Hangar Deck Operations

To complicate matters, cargo is also loaded onto the vessel at the conrep stations on the hangar deck, via CONREP operations, in addition to cargo being transported from the flight deck to the hangar deck, via the elevators 10/15. Typically, it takes about 35-40 personnel to begin the process of unloading the cargo from the conrep stations to the queues and/or the lower level elevators. (Queues as discussed herein may be first in first out (FIFO) or other order, based on the instructions from the computer infrastructure.) It may also take an additional 30-40 personnel to unload the flight deck elevators and place this cargo into queues or lower level elevators 10/15.

Similar to the flight deck operations, operators will begin inventorying the items received at the conrep stations by use of the automatic identification detecting scanners, bar code scanners or manual input (or other devices mentioned herein). This information is also transmitted to the computer infrastructure 30 for storage and later use in accordance with the invention. In addition, as the cargo is received from the flight deck, the automatic identification detecting scanners, bar code scanners or manual input (or other devices mentioned herein) will provide the location and specific item information to the computer infrastructure for later use. In embodiments, the operators on the hangar deck can be automatically notified that cargo has arrived from the flight deck, and be immediately instructed to transport such items to certain locations by way of certain predefined transport paths.

With the identification and location information provided to the computer infrastructure 30, each of the operators will be instructed to place certain ordnance and/or other items in particular locations, whether in queues or on certain lower level elevators in a certain order. The operators are notified and instructed of such coordinated efforts individually or in teams by the computer infrastructure 30 via the external devices 70. As the computer infrastructure 30 is configured to dynamically plan and coordinate the movement of the cargo (and certain equipment (e.g., elevators, smart carts, etc.)), each item can be placed and transported according to a real-time updated scheduling plan. This is regardless of whether it is received at the conrep stations or via the elevators.

For example, operators can be instructed to place specific items in a first and second queue and other items in one or more lower level elevators. These items can be transported from the conrep stations or the flight deck elevators. As any of the lower level elevators become full and instructed to transport the cargo to a lower deck for unloading, the computer infrastructure 30 will instruct the operators to begin placing all items in the second queue. As the elevator is being unloaded in a lower deck, the computer infrastructure 30 can instruct the operators to continue unloading the flight deck elevators or transport items from the conrep stations to the queues. After the elevator is unloaded at the lower deck and brought back to the flight deck, the computer infrastructure 30 may instruct the operators to place certain items from the second queue into the elevator and other items in the queue. Similar to above, in this operational scheme, the computer infrastructure 30 can instruct the operators to move certain items to certain locations through a certain path to coordinate the movement of the operators.

### Lower Deck Operations

Cargo is received at the lower decks (magazine decks, for example) via several different elevators. Typically, it takes about 40 personnel to begin the process of unloading the cargo from the lower level elevators and either place them in queues, magazines or load them to lower level elevators. The lower level elevators may be unloaded by about an additional 30 personnel.

Similar to the hangar deck operations, operators will begin inventorying the items received from the elevators by use of the automatic identification detecting scanners, bar code scanners or manual input (or other devices mentioned herein). This information is also transmitted to the computer infrastructure 30 for storage and later use in accordance with the invention. In addition, as the cargo is received from the elevators, the operators can be automatically notified that cargo has arrived, and be immediately instructed to transport such items to certain locations by way of certain predefined transport paths. Also, similar to that discussed above, as the computer infrastructure 30 is configured to dynamically plan and coordinate the movement of the cargo, each item can be placed and transported according to a real-time updated scheduling plan.

### Processing According to Aspects of the Invention

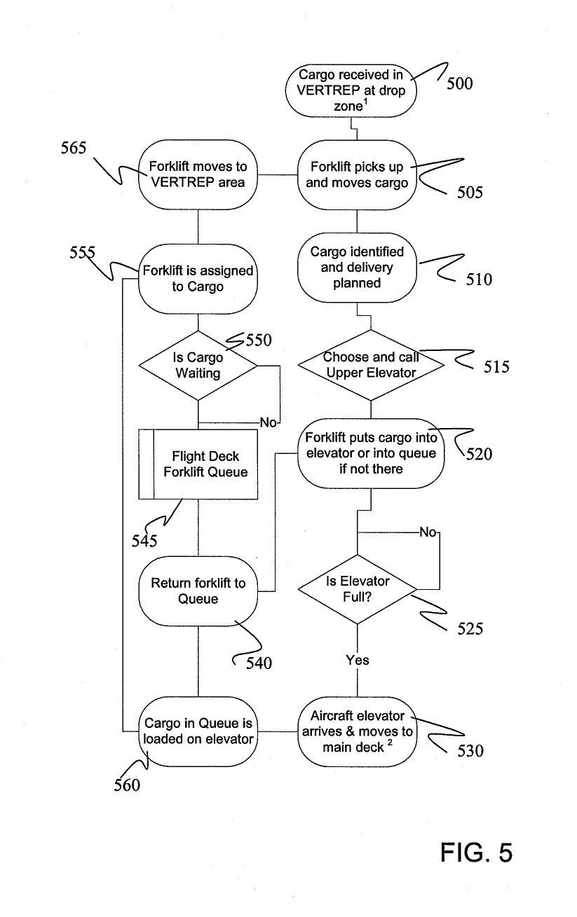

FIGS. 5-13 are flow diagrams showing processing steps in accordance with embodiments of the present invention. The steps of FIGS. 5-13 may be implemented on computer program code in combination with the appropriate hardware as shown and described with reference to FIG. 3. The computer program code may be stored on storage media such as a diskette, hard disk, CD-ROM, DVD-ROM or tape, as well as the storage device or collection of memory storage devices such as read-only memory (ROM) or random access memory (RAM). Additionally, the computer program code can be transferred to a workstation over the Internet or some other type of network.

FIG. 5 is a flowchart showing exemplary steps of flight deck strike-down operations in accordance with the invention. Generally, FIG. 5 shows the processes of the central control computer, e.g., computer infrastructure 30 and more specifically the management system 35 of FIG. 3, and accompanying directions and tasks of operators. (Hereinafter, the computer infrastructure is used to refer to the management system which, in combination with the hardware and software of the computer infrastructure, performs the processes described herein.)

In FIG. 5, the computer infrastructure, having already received the cargo manifest (either electronically or by hand scanning), records the arrival time and determines the best path to the final destination for each item received on the vessel based on historical data or the criteria noted above. Once the best path to the final destination is determined, the computer infrastructure (via the use of the management system) instructs the forklift operator to deliver the items to a certain elevator queue at a certain predetermined location. The computer infrastructure also monitors elevator operations and can make suggestions as to when an elevator is full and when items need to be moved to another elevator. After the forklift operator deposits the cargo in the elevator (or in the elevator queue if the elevator is full or not there), the computer infrastructure instructs the forklift operator to a next task or return to a forklift queue, all via handheld external devices, such as shown in FIG. 3. It should be understood hereinafter with reference to each of the flowcharts that the forklift operator receives instructions from the computer infrastructure (unless otherwise indicated) preferably via a handheld device or a device mounted to the forklift (e.g., the external device 70 of FIG. 3.)

More specifically, at step 500, cargo is received by VERTREP maneuvers at a drop zone. The drop zone may be, for example, the access stations of FIG. 1. As the cargo is received on the vessel, it may be inventoried, and the reconciliation (building of an inventory log and comparing to the manifest) of such items may begin using the computer infrastructure of FIG. 3. At step 505, a forklift operator is instructed to retrieve the cargo and move the cargo to either a queue or an elevator as discussed herein. It should be understood by those of skill in the art that the present invention is not limited to the use of forklifts or forklift operators, but can include any automated or semi-automated equipment or manual operations.

At step 510, the cargo is identified by use of RFID tags, bar codes or manual input. In the case of RFID, the item information is automatically received by a RFID receiver and transmitted to the computer infrastructure of FIG. 3. As in any of the embodiments, the retrieval of the item RFID can be via a handheld device mounted to a forklift or located at a location such as at the elevators or queuing stations(e.g., the external device of FIG. 1). Similarly, the bar code information can be retrieved by a handheld external device, such as a PDA as described with reference to FIG. 3. Alternatively, the identification of the item can be manually input into the external device and transmitted to the computer infrastructure of FIG. 3. The item information is then transmitted to the computer infrastructure directly or via a remote tower. The computer infrastructure can then reconcile such item information in its database (e.g., storage system 60) and instruct shipboard personnel, at several different stations, as to the appropriate action to undertake with respect to the movement, assembly, disassembly, inspection, storage of such items, etc. of the items.

In addition to retrieving the information, at step 510, the computer infrastructure of FIG. 3, for example, can begin the planning process. The planning process includes, for example, controlling material flow, planning, reporting, scheduling, and inventory for shipboard movement of specific cargo or items. (Specific cargo or items as used herein are identified by the computer infrastructure to be processed in accordance with the appropriate processes described herein. The identification of the specific product for planning purposes may be based on priority, safety, or other planning needs, e.g., items that have to be placed last in to be retrieved first out.) The planning process is a dynamic process such that any subsequently identified item can be coordinated with the movement of any previously identified item. For example, a first identified item can be initially scheduled to be moved to a lower deck, but will now be placed in a queue as a second, subsequent item has been identified as a more important item to be moved.

At step 515, the system and method of the invention can select and call any of the appropriate elevators or other moving mechanisms such as semi or fully automated carts. At step 520, the forklift operator places the cargo into the elevator or into an elevator queue, as instructed by the computer infrastructure. At step 525, a determination is made as to whether the elevator is full. This determination may be made by the computer infrastructure by reconciling the dimensions of the specific item, e.g., weight, dimensions, etc, already (or about to be) placed in the elevator with the elevator capacity, e.g., weight limits, floor area, and volume. If the elevator is not full, the computer infrastructure will instruct the forklift operator to load additional items into the elevator, and then return to step 525. If the elevator is full, at step 530, the elevator will be instructed to move to another level, preferably a hangar level in an aircraft carrier application. At step 560. the operator places the items in the elevator queue.

Returning to step 520, if the cargo is placed into a queue or the elevator, the forklift operator is then instructed to return to the forklift queue(s), at step 540. At step 545, the computer infrastructure determines whether any additional cargo is waiting at the queue or other location. Again, this determination may be made by the computer infrastructure as it has inventoried and knows the placement of each item on the vessel. If there is no additional cargo, the process loops through step 545 until additional cargo is in the queue or other location. At step 550, the computer infrastructure assigns the forklift operator to retrieve additional items and instructs the forklift operator to place the cargo into a specified elevator at step 560. At step 565, the forklift operator moves back to the VERTREP area.

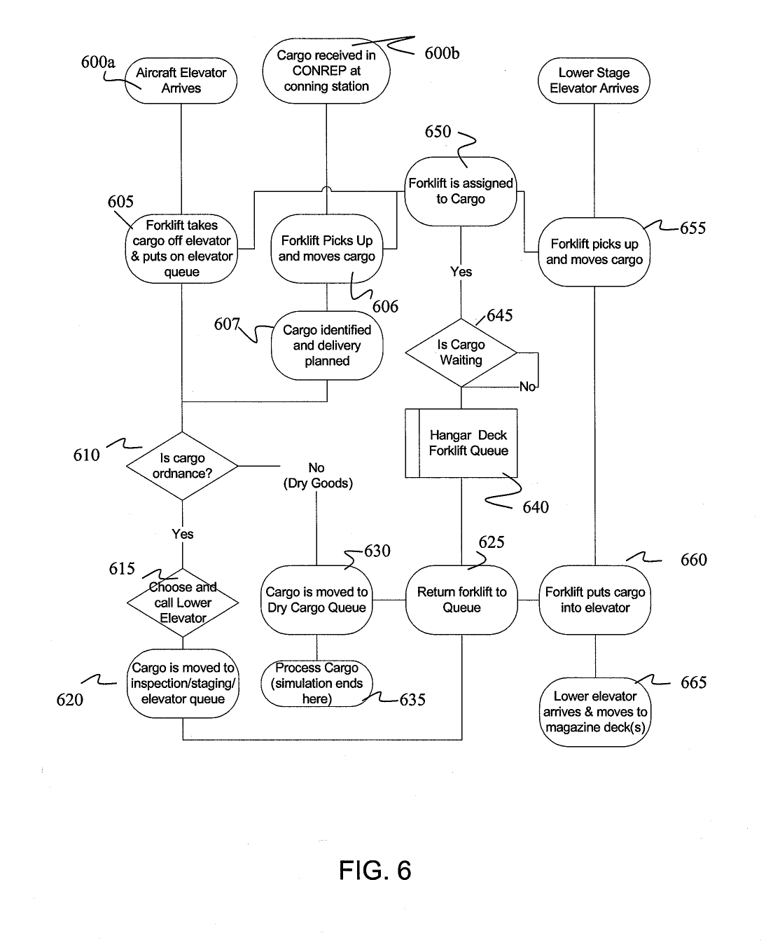

FIG. 6 is a flowchart showing exemplary steps of hangar deck strike-down operations in accordance with the invention. As should be appreciated, in an aircraft carrier application, the hangar deck is the hub of activity during strike-down for an underway replenishment, either VERTREP or CONREP. As discussed above, the items from VERTREP arrive from the flight deck via one or more elevators, while items also arrive at CONREP conrep stations. On the hangar deck there is also a queue of forklifts and items. As cargo is ready for movement, the computer infrastructure (via the management system) assigns forklifts to the cargo. The forklift operators are notified via the external device to the assigned cargo and the location of drop off. The forklift operator picks up the cargo, at which time it is rescanned, using any of the appropriate processes described, and is transported to its destination (usually a lower stage elevator). After the forklift task is complete, the operator is instructed to return to the forklift queue for additional operations.

During the entire process, the computer infrastructure continues to calculate the best route to the final destination (such as a weapons magazine), schedules the movement to prevent collisions and meet any priorities (frozen food must stay frozen), and monitors all aspects of the movement (as with the other embodiments described herein). The computer infrastructure also verifies that all safety rules (such as maximum elevator weights, height restrictions, emission controls (EMCON) restrictions) are followed according to specifications (as will the other embodiments described herein).

More specifically, at step 600a the elevator arrives from an upper level. Also, at step 600b, additional cargo may be received via CONREP operations at the conrep station(s). At step 605, the forklift operator is instructed to remove the cargo from the elevator and put it into another elevator queue, as determined by the computer infrastructure. At step 606, the forklift operator is instructed to remove specific cargo from the conrep station and, at step 607, the cargo is identified using the processes described herein, e.g., RFID, barcode and/or manual input.

At step 610, the computer infrastructure determines whether the cargo is ordnance or other type of items such as dry goods. This is accomplished via the specific ID of the item, retrieved in the previous step. If the cargo is ordnance, for example, the computer infrastructure or the operator may select an elevator. At step 620, the cargo is moved to the staging and inspection area of the elevator queue. At this time, the ordnance can be inspected to ensure that it is not damaged or has not been tampered with by unauthorized personnel. In the latter situation, an operator can inspect the tamper labels and input such information into the external device for uploading to the computer infrastructure.

If the cargo is not ordnance, the cargo can be moved to the dry cargo queue at step 630. Again, the operator will be instructed as to the placement and timing and, hence coordination, of such movement, all under the control of the computer infrastructure. At step 635, the cargo is processed.

At step 625, stemming from step 620 or step 630, the forklift operator is instructed to return to the forklift queue. At step 640, the forklift operator returns to the hanger deck forklift queue. At step 645, the computer infrastructure determines whether there is any additional cargo waiting to be moved. Again, this may be accomplished by the items having been inventoried and, as such, the computer infrastructure maintains track of the items as they are moved about the vessel. If there are no items, the system loops through step 645.

If there are additional items, the forklift operator is assigned to the cargo, at step 650. The assignment will be provided by the computer infrastructure to the external device. The forklift operator can be instructed to step 605, step 606 or step 660. At step 660, the forklift operator is instructed to retrieve specific cargo and move the cargo into the elevator (step 660). (Step 660 may also stem from steps 625.) It should be recognized by those of skill in the art that the computer infrastructure, being implemented with the existing ship wide systems can easily determine when an elevator has arrived at a specific deck. At step 665, the elevator is instructed, either by the computer infrastructure or the operator, to lower to the magazine deck. As with the processes described with reference to FIG. 5, the elevator can be monitored to determine when it becomes full.

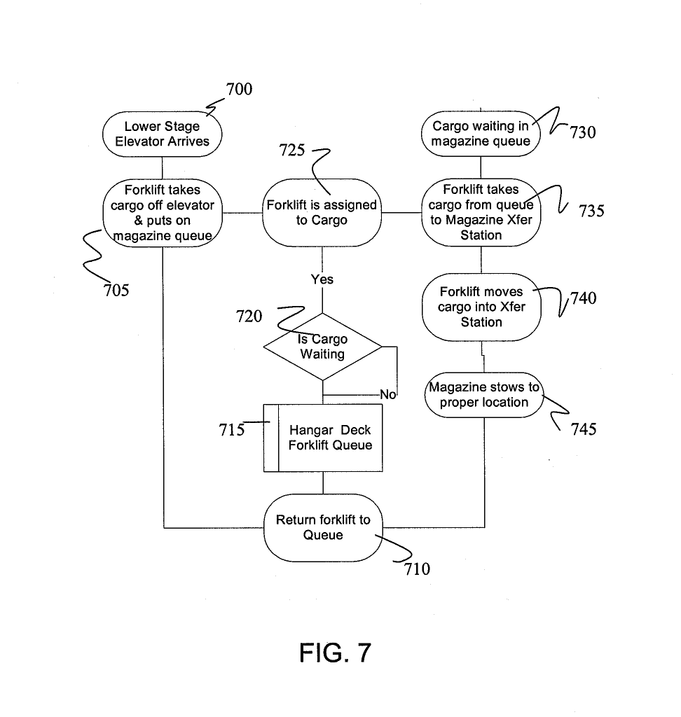

FIG. 7 is a flowchart showing exemplary steps of magazine deck strike-down operations in accordance with the invention. The final destination of storage for ordnance is the weapons magazine. In implementations, the magazine is an automated system; although the actual design of the magazine will not affect the processes described herein. Generally, forklift operators are instructed to wait in queues. As the elevator arrives, the forklift operator is notified via the external device to take the cargo to a specific location (e.g., a transfer station to the magazine). After taking the cargo to the specific location, the forklift operator is instructed to return to the forklift queue for the next assignment. As noted throughout, the system and method of the invention maintains full system visibility during the move and tracks all cargo to its final destination (via the RFID, barcode or manual input).

More specifically, at step 700, the lower stage elevator arrives at the lower deck. At step 705, the forklift operator is instructed by the computer infrastructure to retrieve the cargo from the elevator and to place the cargo in the magazine queue. At step 710, the forklift operator is instructed to return to the queue. At step 715, the forklift operator remains in the forklift queue and waits for further cargo, which is determined at decision block 720, via the processes described already. If there is additional cargo, the forklift operator is assigned to retrieve specific cargo (step 725) and place it in the queue (step 705).

Also, at step 730, cargo may already be waiting in the magazine queue. At step 735, the forklift operator is instructed to retrieve specific cargo from the queue and bring it to the magazine, where at step 740, in embodiments, the forklift operator will bring the cargo, e.g., ordnance, to an automated or semi-automated transfer station. At step 745, the magazine stows to the proper location under the control of the computer infrastructure. The process then returns to step 710.

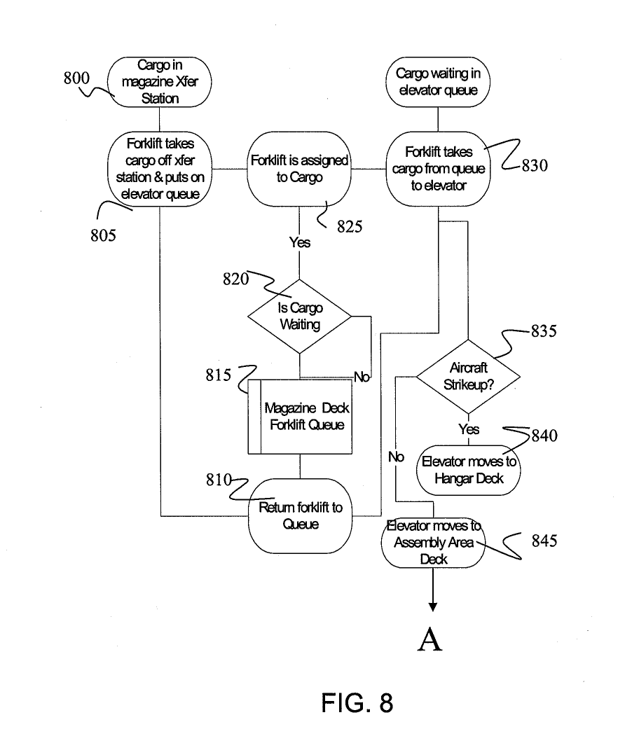

FIG. 8 is a flowchart showing exemplary magazine deck strike-up operations in accordance with the invention. The strike-up operations of FIG. 8 involve removing the cargo from its storage locations and transporting it to the point of use. In the case of ordnance, the strike-up operations involve locating the ordnance, removing the ordnance from containers, transporting them to an assembly area for assembly and verification, transporting to queues and ordnance farm on the flight deck, from which the ordnance is manually loaded onto aircraft. These processes can be monitored, tracked and coordinated by the computer infrastructure as further described herein.

More specifically, at step 800, cargo is determined to be in the magazine or magazine transfer station. At step 805, the forklift operator is instructed to take specific ordnance from the magazine to the elevator queue. These instructions may include, for example, which ordnance is to be moved, the manner of moving the ordnance, the placement in the queue, etc. (much like any item in other operations). In embodiments, the system and method of the invention can also coordinate the delivery within the magazine by interfacing and coordinating with the magazine's control system. At step 810, the forklift operator is instructed to return to the forklift queue. At step 815, the forklift operator remains in the magazine deck forklift queue until a determination is made, at step 820, that additional cargo (e.g., ordnance) is waiting to be retrieved by the forklift operator. At step 825, the forklift operator is assigned to the cargo, and is instructed to take specific cargo to a certain location at step 805.

Also, the forklift operator may be instructed to retrieve specific cargo from the queue to the elevator, at step 830. In this branch, the cargo was previously waiting in the elevator queue. At step 835, the computer infrastructure determines whether there is a strike-up operation. If so, at step 840, the computer infrastructure instructs the elevator to move to the hangar deck. If there is no strike-up operation, the elevator is instructed to move to the assembly area deck, at step 845.

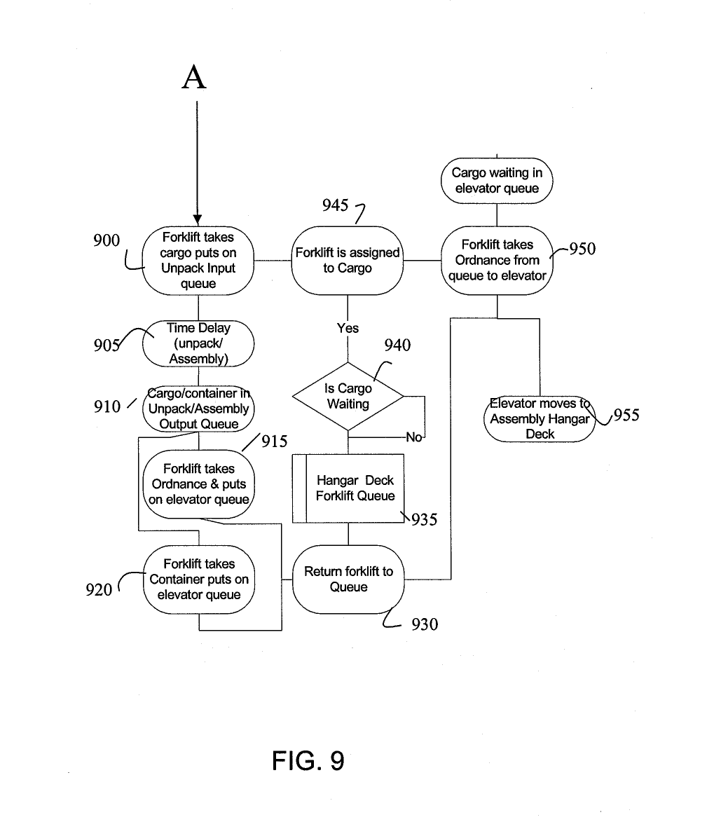

FIG. 9 is a flowchart showing exemplary steps of unpack area strike-up operations in accordance with the invention. Stemming from step 845, the process continues at step 900. At step 900, the forklift operator is instructed to retrieve the cargo, e.g., ordnance, from the elevator and deliver it to the unpack input queue. In embodiments, there may be a time delay provided in the processes at step 905. At step 910, the operator is instructed to unpack and assemble specific ordnance. The cargo is unpacked from a container and the forklift operator will be instructed to take specific ordnance to the elevator queue (step 915) and the container to another elevator queue (step 920). As should be appreciated by those of skill in the art, the timing of such maneuvers is coordinated and synchronized by the computer infrastructure. Alternatively, as the cargo is unpacked from the container, prior to the assembly of the ordnance, the computer infrastructure can instruct the forklift operator to move the container into its queue prior to the ordnance being moved into its queue. This can save valuable time and also ensure that the forklift operators are working in the most efficient manner.

At step 930, the forklift operator is instructed to return to the forklift queue. At step 935, the forklift operator is in the hangar deck queue waiting for a determination as to whether there is any additional cargo (step 940). If there is additional cargo, as monitored by the computer infrastructure, the forklift operator will be assigned to the additional cargo at step 945. The forklift operator can then be instructed to return to the processes associated with step 905, or to the processes of step 950.

At step 950, the forklift operator is instructed to retrieve specific ordnance from the queue and take it to the elevator. At step 955, under the control of the computer infrastructure or manual input, the elevator is instructed to move to the assembly hangar deck. Again, the computer infrastructure can determine when the elevator is full and/or has the appropriate cargo loaded therein the processes described above.

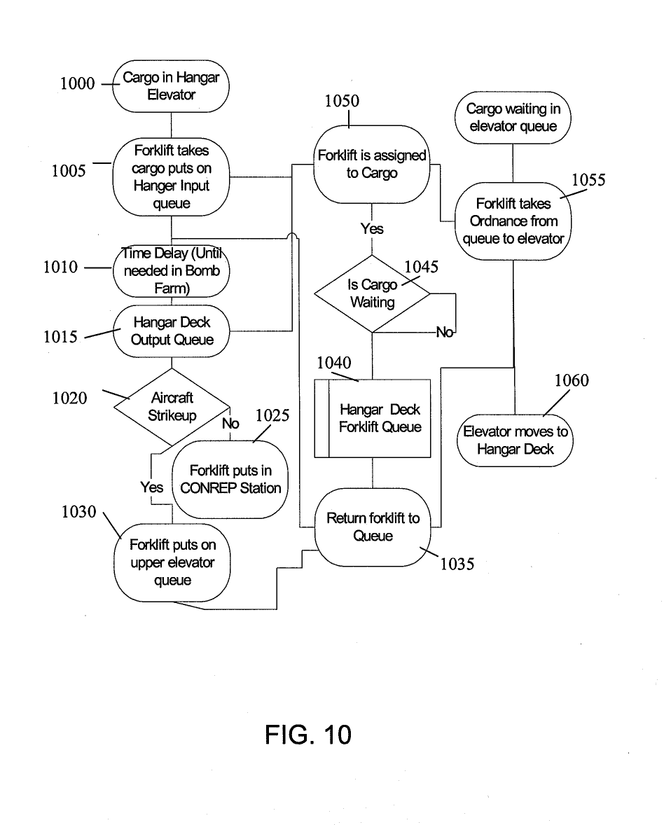

FIG. 10 is a flowchart showing exemplary steps of hangar deck strike-up operations in accordance with the invention. At step 1000, cargo is determined to be in the hangar elevator. At step 1005, the forklift operator is instructed to retrieve specific cargo and place it in the input queue. The forklift operator is then instructed to return to the forklift queue at step 1035.

At step 1010, there may be a time delay prior to the placement of the ordnance in the ordnance farm or other cargo in another location. At step 1015, specific cargo is designated as being in the hangar deck output queue. At step 1020, the computer infrastructure determines whether there is a strike-up operation. If there is no strike-up operation, at step 1025, the forklift operator is instructed to place specific cargo in the CONREP conrep station or other location. If there is a strike-up operation, the forklift operator is instructed to place the specific ordnance (or other items) in the upper elevator queue. The forklift operator is then instructed to return to the forklift queue at step 1035.

At step 1040, the forklift operator is in the forklift queue waiting for a determination as to whether any additional cargo is waiting to be retrieved by the forklift operator (step 1045). If there is additional cargo, the computer infrastructure will assign the forklift operator to the specific cargo at step 1050. The process can either return to step 1015 or proceed to step 1055. At step 1055, the forklift operator is instructed to retrieve specific ordnance from the queue to the elevator. At step 1060, the elevator is instructed to move to the hangar deck by way of control of the computer infrastructure or manual input.

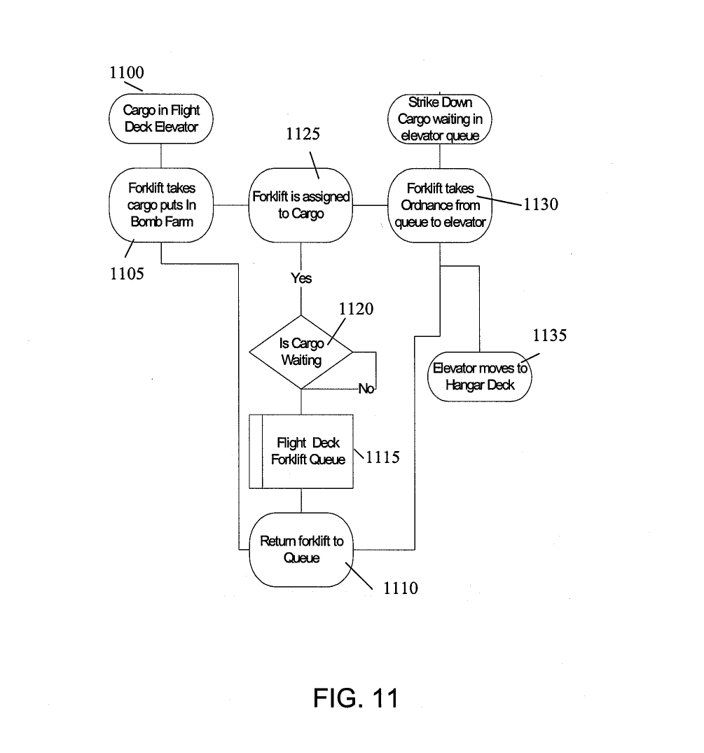

FIG. 11 is a flowchart showing exemplary steps of flight deck strike-up operations in accordance with the invention. At step 1100, cargo is determined to be in the deck elevator. At step 1105, the forklift operator is instructed to retrieve specific cargo and place it in the ordnance farm. At step 1110, the operator is instructed to return to the forklift queue. At step 1115, the forklift operator is in the forklift queue, waiting for the computer infrastructure to determine whether there is any additional cargo waiting to be retrieved by the forklift operator (step 1020). If there is additional cargo (e.g., ordnance), the computer infrastructure will assign such specific cargo to the forklift operator at step 1125. The process will either return to 1115 or proceed to step 1130.

At step 1130, the forklift operator is instructed to retrieve specific ordnance from the queue and transport it to the elevator. At step 1135, the elevator is instructed to move to the hangar deck. The movement of the elevator, again, may be automated and controlled by the computer infrastructure or may be a manual process.

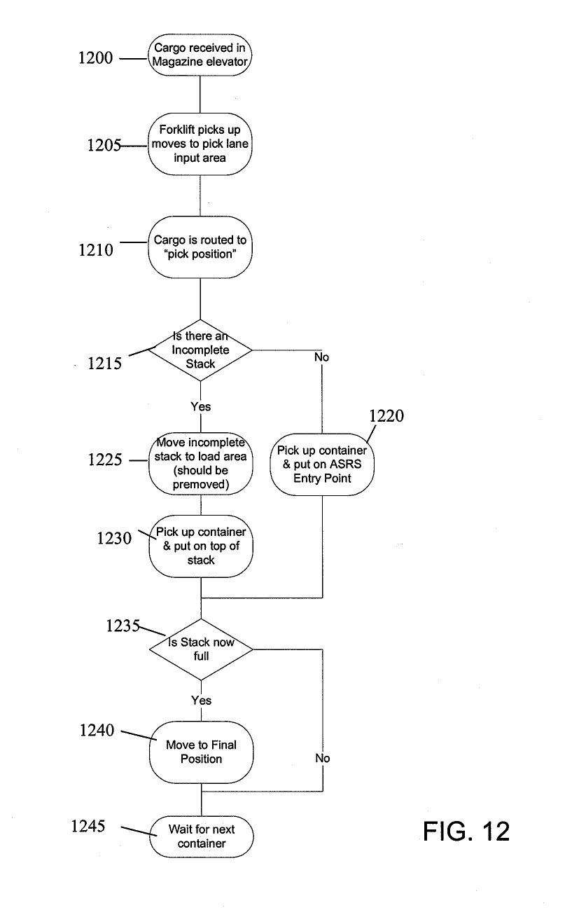

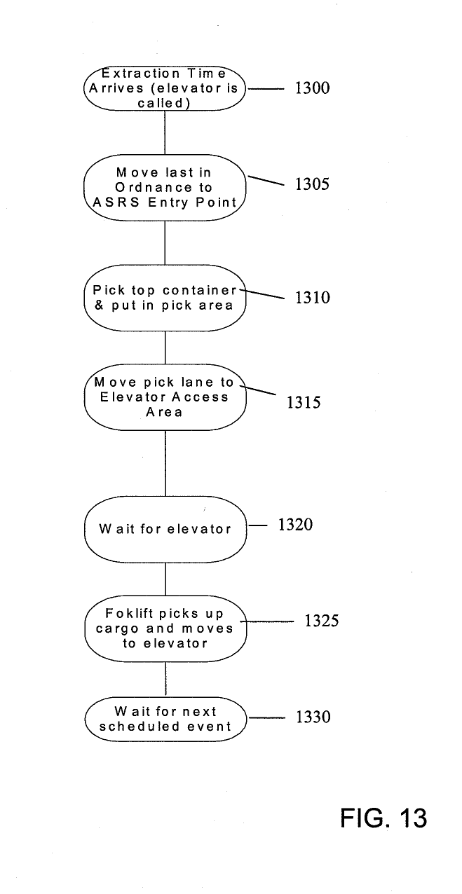

FIGS. 12 and 13 are flowcharts showing exemplary steps of magazine movement operations in accordance with the invention. At step 1200, cargo (e.g., ordnance) is received in the magazine elevator. At step 1205, the forklift operator is instructed to retrieve the cargo and place it in a pick lane input area or other designated location, under the instructions of the computer infrastructure. At step 1210, the computer infrastructure routes the cargo to a “pick location”. At step 1215, the computer infrastructure determines (or it is manually determined) whether the stack of ordnance/containers is complete. The determination as to whether the stack is complete may be made by many methods. For example, a photodiode type sensor can detect that the stack is at a certain height, after a light beam is interrupted. The sensor can then send a signal to the computer infrastructure. Alternatively, as the computer infrastructure is capable of tracking the position of the containers/ordnance, and knowing the height and/or other dimensions of the containers/ordnance, it can determine when the containers/ordnance have exceeded a certain threshold criteria, e.g., above a certain height, as they are being stacked. Also, weight sensors or other known sensors can determine whether a stacking location is full or empty.

If the stack is complete, at step 1220, the forklift operator (or other automated or semi-automated equipment, e.g., smart carts, etc.) will be instructed to pick up the container and place them at the magazine entry point. If the stack is incomplete, at step 1125, the forklift operator (or other automated or semi-automated equipment) will be instructed to move the incomplete stack to the load area or other designated location. At step 1230, the forklift operator (or other automated or semi-automated equipment) is instructed to retrieve the container(s) and place it on the stack. At step 1235, another determination is made by the computer infrastructure (or manually made) as to whether the stack is full. If the stack is full, at step 1240, the forklift operator (or other automated or semi-automated equipment) is instructed to move the stack to the final position and wait for a next container at step 1245. If the stack is not full at step 1235, the forklift operator (or other automated or semi-automated equipment) is instructed to wait for the next container at step 1245.

In FIG. 13, at step 1300, as extraction time arrives, the elevator can be called by the computer infrastructure or manually by an operator. At step 1305, the cargo, e.g., ordnance, is moved to the entry point of the magazine. At step 1310, the forklift operator or other automated or semi-automated equipment is instructed to retrieve the top container and place it in the pick area or other designated location. At step 1315, the forklift operator or other automated or semi-automated equipment is instructed to move the cargo in the pick lane to the elevator access area. At step 1320, the forklift operator or other automated or semi-automated equipment will be instructed to wait for the elevator. At step 1325, the forklift operator is instructed to retrieve specific cargo and move it to the elevator. At step 1330, the forklift operator or other automated or semi-automated machine is instructed to wait for the next container.

### Exemplary Display Views of External Devices Implemented in Accordance with the Invention

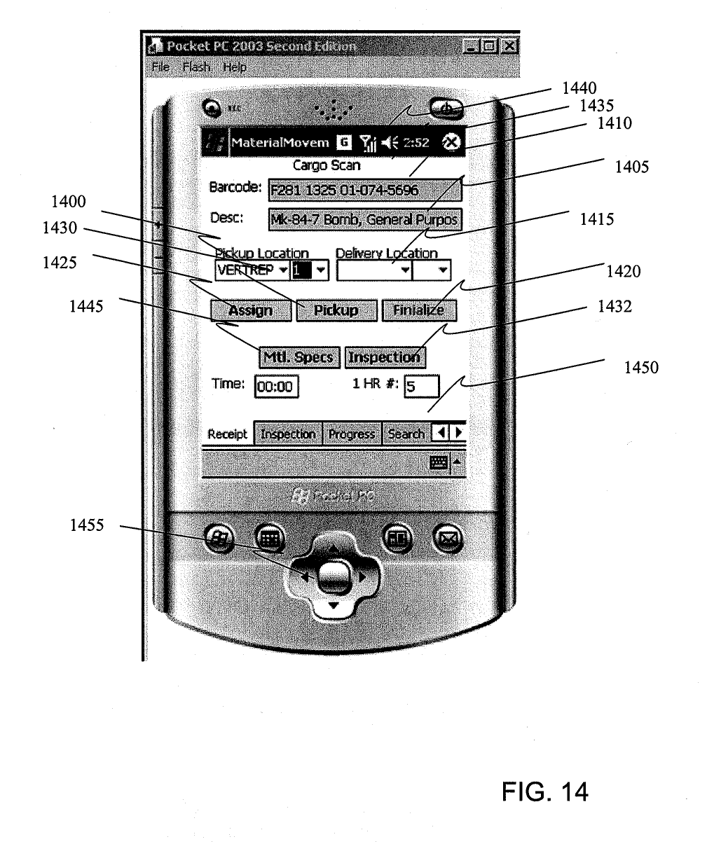

FIGS. 14-17b show exemplary user interfaces implemented in accordance with the invention. For example, the external device 70 allows an operator to interface with the computer infrastructure 30 to provide the features discussed herein. The external device 70 is configured to, amongst other features:
Indicate cargo identity;
Provide locations and destinations of cargo;
Indicate the status of the system;
Indicate that manual movement is complete and that the system can proceed with automatic movement;
Allow an operator to stop all automatic movement or portions of the system, schedule cargo arrivals and departures, view cargo departure schedules, view current inventory of cargo, view expected inventory of cargo at a future time, order new cargo, schedule personnel and/or schedule system resources;
Provide video display of what activities are occurring in different parts of the system;
Indicate any error/exception situations;
Direct cargo from one location to another;
Facilitate cargo inspection;
Alert users when schedules cannot be met;
Allow personnel to authenticate themselves;
Allow personnel to configure the system;
Simulate actual shipboard layout;
Display commands sent to automated material movement subsystems;
Display when subsystems are not functioning properly; and/or
Inform the operator to prevent certain equipment and areas from being used such as, for example, vehicles, elevators, magazines, queuing areas, weapon assembly areas, etc. This can be done by a notification on the external display.

With the proper authorization, the external device 70 is also configured to override actions and complement instructions received from the computer infrastructure 30. For example, the external device 70 allows the operator to configure:
The number and type of vehicles to be used for certain operations;
The number and locations of queuing locations;
The number and type of cargo to be stored in certain storage locations;
The paths of the cargo flow;
The reallocation of system components (e.g., reallocating vehicles to different decks, elevators, holds, magazines) during operations; and/or
Override system instructions based on emergency situations.

As many of the features of the present invention are configurable at the external device 70, it is contemplated that any modifications and/or changes will be transmitted to the computer infrastructure 30. The computer infrastructure 30 will then update its records and send the modifications and/or changes to other operators, as required. This allows full visibility of the modifications and/or changes to the operations of the vessel.

The external device 70 can also display information in a three dimensional graphical representation. This information may be, for example, cargo movement progress, current location, and queuing through the system. The computer infrastructure can also place labels to three-dimensional views of cargo to identify current position of the view (and cargo/goods). The external device 70 can also display component failures, degraded mode of operation, and automatically provide the operator with messages, warning, alerts and error messages. (This same information may also be provided on the terminal of the computer infrastructure or through email or paging systems.)

FIG. 14 shows an exemplary display of flight deck operations. This same or similar display may be used for lower deck operations, during the strike-up or strike-down operations. During the strike-up or strike-down operations, the operator would typically be using the Cargo Scan menu of the external device. In FIG. 14, the display shows a pickup location field 1400, e.g., VERTREP station 1400 (station 1), which instructs the operator to a certain location. It should be understood that the pickup (and delivery location) can be any station or location on the vessel such as a conrep station, elevator or the like. As the operator retrieves the item, the external device will display the item information in the description field 1405 and the bar code or other identification in the identification field 1410. The information in fields 1405 and 1410 are provided directly from the item itself, through e.g., a bar code scanner or RFID. Alternatively, the computer infrastructure can provide this information, after it receives the item ID.

In addition, the external device will also provide a delivery location at fields 1415. Upon delivery, the operator would select the “Finalize” button 1420. The operator also can view the assignment information and pickup information by selecting the “Assign” button 1425 and “Pickup” button 1430, respectively. Selecting the “Inspection” button 1432 will display inspection information to the operator. The external device also has an audio alert 1435 and a signal strength meter 1440 (for transmitting and receiving RFID and other information), common to all external devices. The operator also has access to the material specifications via button 1445. The operator can also view different screens via tabs 1450, all of which can be accessed by touch screen or the control 1455. The control 1455 can also provide control to other functions of the device such as scrolling to different pickup locations, delivery locations, etc.

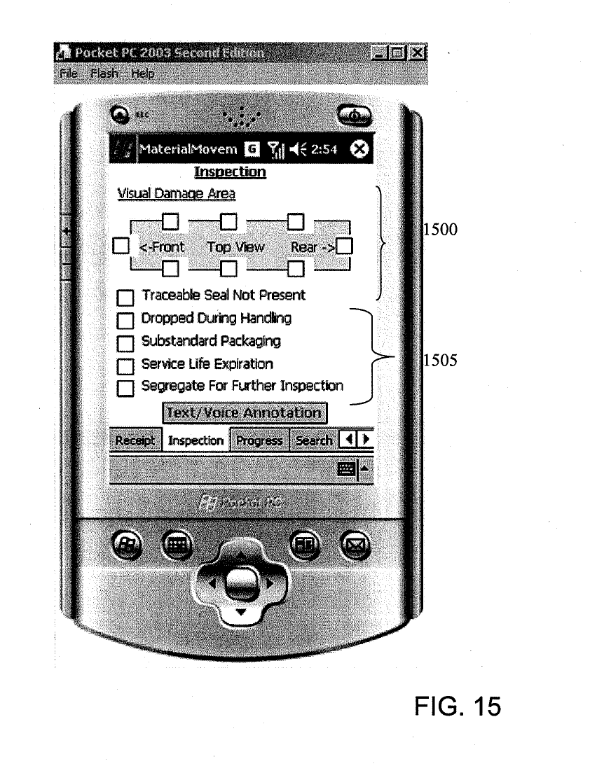

FIG. 15 shows an exemplary display of an inspection operation. The inspection screen may be viewed by, for example, selecting the inspection tab or inspection button of FIG. 14. As shown in FIG. 15, for example, inspection data can be entered into the external device, which will then be transmitted to the computer infrastructure for analysis and storage. The inspection screen includes visual damage area 1500 as well as other check box inspection information (1505). The other check box inspection information may include, but not limited to, traceable seal information, handling information (dropped), packing information, expiration information and the ability to notify other users to segregate the item for further inspection, all generally noted at reference numeral 1505. In further embodiments, the interface may include inspection information indicating that: the cargo did not arrive in a proper fashion; the cargo was not in it proper configuration; the cargo was not in its proper container; the cargo was mislabeled; the tamper proof label was missing or damaged, etc. Any of this information can be determined by an automated visual recognition system such as an optical scanner or manually, which is reconciled with stored information in the computer infrastructure. Text and voice annotation is also possible.

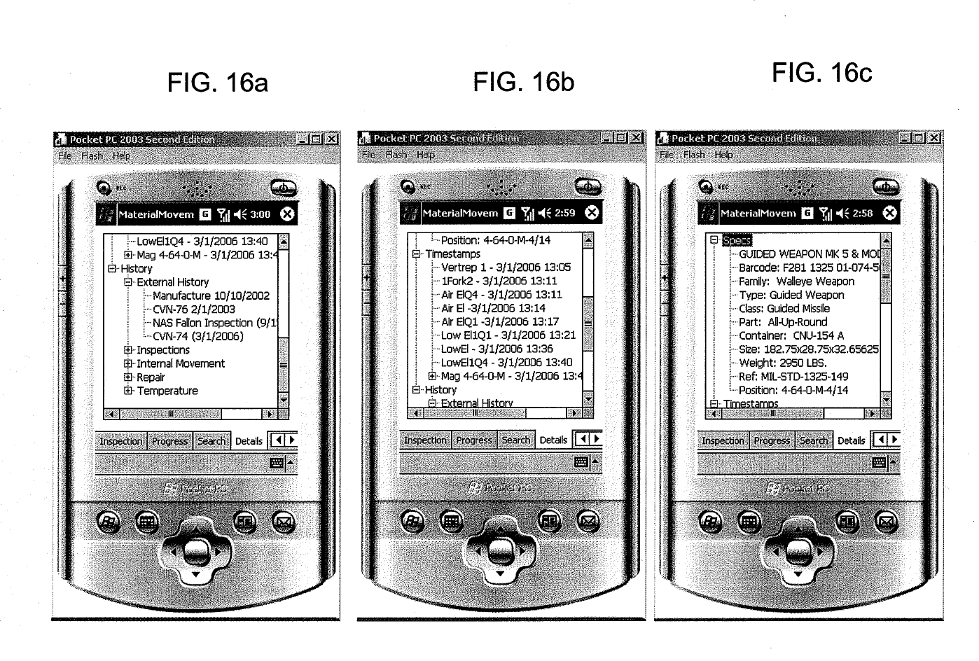

FIGS. 16a-16c show various detail pages for military inspection. These screens can be accessed by the selection of the military inspections screen button 1445. Alternatively, this information can be displayed by the selection of the details tab. The information, in this example, is displayed in a hierarchical format. The information can be selected by scrolling to the particular item of interest and selecting such item. This may be accomplished by the use of the control 1445.

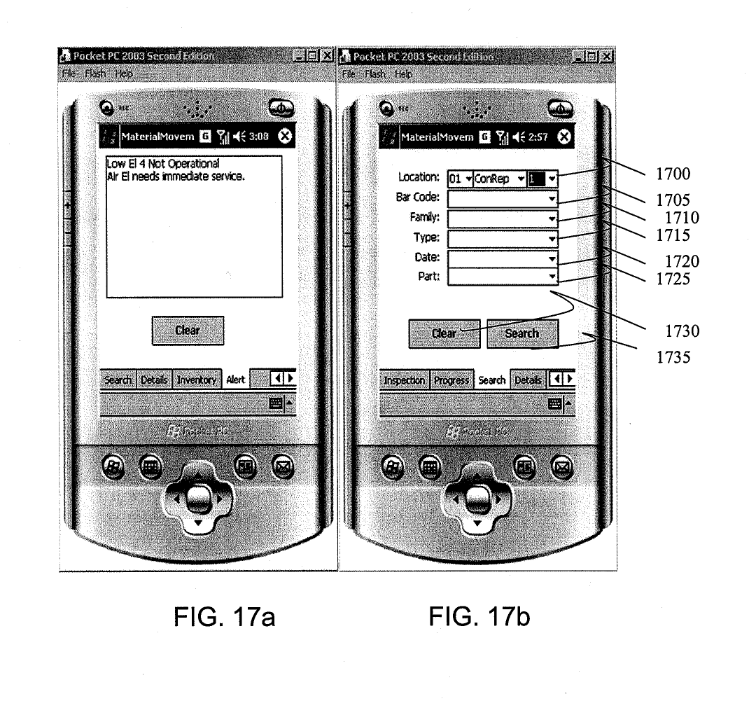

FIGS. 17a and 17b show exemplary displays for alert and search operations during strike-up or strike-down operations. The display of FIG. 17a provides an alert to an operator. This alert may range from operational needs to assistance needs, etc. These alerts are coordinated by the computer infrastructure 30.

FIG. 17b shows a search display. This display includes the following fields: location 1700; bar code 1705; family 1710; type 1715; date 1720; and part 1735. It should be recognized by those of skill in the art that the above fields are provided for illustrative purposes and that the present invention should not be limited to such fields. During search operations, the operator may select any of the fields and input information, such as, search for CONREP 1 station. The search criteria will be provided to the computer infrastructure, by selecting the “search” button 1720. The operator may also clear the query by selecting the “clear” button 1735. The search information, in embodiments, will be transmitted to the computer infrastructure, which has inventoried all items on board the vessel, through strike-down operations, in embodiments. As such, the computer infrastructure can locate a requested item and return the item location to the operator on the display of the external device.

While the invention has been described in terms of embodiments, those skilled in the art will recognize that the invention can be practiced with modifications and in the spirit and scope of the appended claims.

What is claimed:

1. A system environment, comprising:
a computer infrastructure configured to receive item identification from remote sources and provide transporting instructions based on the item identification and predetermined criteria to operators for movement of items adapted to be used within a vessel; and
at least one external device configured to at least receive the transporting instructions from the computer infrastructure.

2. The system environment of claim 1, wherein the computer infrastructure is one of a centralized control management system or a decentralized control management system.

3. The system environment of claim 1, further comprising at least a bar code scanner or an RFID device to receive the item identification and a transmitter to transmit the item identification to the computer infrastructure.

4. The system environment of claim 1, wherein the computer infrastructure is configured to provide real time status and control material flow which includes at least one of planning, reporting, and scheduling of the items.

5. The system environment of claim 1, wherein the predetermined criteria is at least one of:
where the items are expected to be used;
type of the items;
expected weather and sea conditions and/or current sea and weather conditions;
trim of the vessel;
arrival time;
number of items in certain system queues;
scheduling of equipment;
assembly locations;
disassembly locations;
location of spare parts;
characteristics of the items;
current storage space in certain locations;
expected storage space in certain locations;
current Emission Control State;
height of item cargo stacking;
physical limits on a path to a storage location and at the storage location;
physical limits at the storage location;
actual traffic flow on a path to the storage location to prevent collision;
anticipated traffic flow on a path to the storage location to prevent collision; and
personnel scheduling.

6. The system environment of claim 1, wherein the computer infrastructure is configured to control and instruct automated, semi-automated or manual equipment.

7. The system environment of claim 1, wherein the item information is obtained by at least one of:
a barcode scanner;
an active or passive RFID device scanner;
a profile scanner;
a photo eye;
a physical contact sensor or switch; and
a vision system.

8. The system environment of claim 1, further comprising at least one device to detect characteristics of the items.

9. The system environment of claim 1, further comprising a device to detect item location and/or characteristics of the items including at least one of:
a thermometer or other temperature measuring device;
a gas sensing instrument;
a radioactivity sensing instrument;
a biohazard sensing instrument;
an audio signal device;
a device that senses wires, light reflective paint, or emitters embedded in a floor or deck or near material movement passageways;
an optical scanner;
a device that senses emitters embedded in vehicles or material movement devices; and
a weight measurement device.

10. The system environment of claim 1, wherein the computer infrastructure is configured to monitor the location of the items.

11. The system environment of claim 10, wherein the computer infrastructure is configured to monitor a path of travel of the item.

12. The system environment of claim 1, wherein the computer infrastructure is configured to use historical information of the items to determine a path of travel.

13. The system environment of claim 1, wherein the computer infrastructure is configured to be overridden by the at least one external device.

14. The system environment of claim 1, wherein the computer infrastructure is configured to interface with at least one of inventory and supply systems, local or off-ship supply systems, shipboard databases and external databases, monitoring equipment throughout the vessel, and same or disparate systems from same or different manufacturers.

15. The system environment of claim 1, wherein the computer infrastructure is configured to provide inventory information of the items and reconcile the items with a manifest.

16. The system environment of claim 1, wherein the computer infrastructure is configured to calculate space and/or scheduling requirements for in system equipment and item queuing; and deliver the items using a preset schedule at certain defined times.

17. The system environment of claim 1, wherein the external device is configured to at least one of provide status and identification information to an operator about the items and override systems under control of the computer infrastructure or instructions received by the computer infrastructure, which are provided to other external devices.

18. A system comprising a computer infrastructure configured to:
receive item information from at least one remote sensing device at different locations;
use the item information to determine and provide different real-time scheduling information and transportation paths of items associated with the item information to various users; and
continually update information about a location and the transportation paths of the items as the items travel to various locations.

19. The system of claim 18, further comprising external devices which are configured to receive the scheduling information and real-time updated information about the transportation paths of the items at various locations as the items are detected or moved to the various locations.

20. The system of claim 18, further comprising detecting mechanisms which detect item and/or equipment location.

21. The system of claim 19, wherein the external device is configured to override the instructions of the computer infrastructure.

22. The system of claim 21, wherein the external device is configured to provide at least one of searching and inspection capabilities to the users.

23. A method, comprising:
receiving item information of a plurality of items as they are received;
receiving location information of the plurality of items as they travel throughout space;
coordinating in real-time product paths and scheduling of the plurality of items based on a location of the plurality of items and the item information; and
providing different scheduling information and product paths to different users at different locations based on the coordinating in real-time the product paths and the scheduling of the plurality of items.

24. The method of claim 23, further comprising reconciling the item information with a final storage destination for each of the plurality of item.

25. A method of coordinating material flow through a vessel, comprising:
inventorying items as they are received at different stations throughout adapted to use with the vessel;
tracking the items as they are moved to different locations throughout the vessel; and
providing different real-time scheduling and transportation information to users or automated material movement equipment at different stations throughout the vessel based on item criteria, movement of the items throughout the vessel and current location of the items at particular stations.
